(19) United States
(12) Patent Application Publication
(10) Pub. No.: US 2024/0314840 A1
(43) Pub. Date: Sep. 19, 2024

(54) SIDELINK COMMUNICATION ON UNLICENSED CARRIERS

(71) Applicant: ZTE Corporation, Shenzhen (CN)

(72) Inventors: Wei LUO, Shenzhen (CN); Lin CHEN, Shenzhen (CN); Youxiong LU, Shenzhen (CN)

(73) Assignee: ZTE Corporation, Shenzhen (CN)

(21) Appl. No.: 18/673,475

(22) Filed: May 24, 2024

Related U.S. Application Data
(63) Continuation of application No. PCT/CN2021/140919, filed on Dec. 23, 2021.

(51) Int. Cl. H04W 74/0808; H04W 16/14; H04W 74/08; H04W 76/40

(52) U.S. Cl. CPC H04W 74/0808; H04W 16/14; H04W 74/0875; H04W 76/40

(57) ABSTRACT

This document generally relates to a systems, apparatus, devices, and methods for wireless communication. In an implementation, a first user device: performs a listen-before-talk (LBT) procedure in an unlicensed carrier for a sidelink transmission; determines a result of the LBT procedure; in response to determining that the result is a LBT success, transmits a sidelink signal on a channel in the unlicensed carrier to a second user device; and in response to determining that the result is a LBT failure, a physical layer entity of the first user device sends a LBT failure indication to a medium access control (MAC) layer entity of the first user device.

### CROSS-REFERENCE TO RELATED APPLICATIONS

This application is a continuation of International Patent Application No. PCT/CN2021/140919, filed Dec. 23, 2021. The contents of International Patent Application No. PCT/CN2021/140919 are herein incorporated by reference in their entirety.

### TECHNICAL FIELD

This document is directed generally to sidelink transmissions in wireless communications.

### BACKGROUND

Wireless communications are often performed with user terminal devices and base stations. In addition, wireless communication is performed on carriers or frequency bands. Some carriers are licensed carriers, which are carriers licensed by a governmental or other authoritative entity to a service provider for exclusive use. Other carriers are unlicensed carriers, which are carriers not licensed by such governmental or other authoritative entities. Currently, user terminal devices communicate directly with each other (i.e., without use of a base station) on licensed carriers. However, ways for user terminal devices to communicate directly with each other on unlicensed carriers may be desirable.

### SUMMARY

This document relates to methods, systems, apparatuses and devices for wireless communication. In some implementations, a method for wireless communication includes: performing, with a first user device, a listen-before-talk (LBT) procedure in an unlicensed carrier for a sidelink transmission; determining, with the first user device, a result of the LBT procedure; in response to determining that the result is a LBT success, transmitting, with the first user device, a sidelink signal on a channel in the unlicensed carrier to a second user device; and in response to determining that the result is a LBT failure, sending, with a physical layer entity of the first user device, a LBT failure indication to a medium access control (MAC) layer entity of the first user device.

In some other implementations, a device, such as a network device, is disclosed. The device may include one or more processors and one or more memories, wherein the one or more processors are configured to read computer code from the one or more memories to implement any one of the methods above.

In yet some other implementations, a computer program product is disclosed. The computer program product may include a non-transitory computer-readable program medium with computer code stored thereupon, the computer code, when executed by one or more processors, causing the one or more processors to implement any one of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of layer entities for a communication node.

FIG. 3 shows a flow chart of an example method for wireless communication that includes detecting for listen-before-talk (LBT) failures.

FIG. 4 shows a flow chart of an example method for wireless communication that includes detecting for radio link failures based on numbers of consecutive hybrid automatic repeat request (HARQ) discontinuous transmissions (DTXs).

FIG. 5 shows a flow chart of an example method for wireless communication that includes prioritizing an unlicensed transmission over a licensed transmission.

FIG. 6. shows a flow chart of an example method for wireless communication that includes determining whether to prioritize a sidelink transmission or an uplink transmission based on at least one of a first sidelink prioritization threshold for licensed carriers or a second sidelink prioritization threshold for unlicensed carriers.

FIG. 7. shows a flow chart of an example method for wireless communication that includes determining whether to prioritize a sidelink transmission or an uplink transmission based on at least one of a first uplink prioritization threshold for licensed carriers or a second uplink prioritization threshold for unlicensed carriers.

### DETAILED DESCRIPTION

The present description describes various embodiments of systems, apparatuses, devices, and methods for wireless communications involving sidelink transmissions, including those in unlicensed carriers.

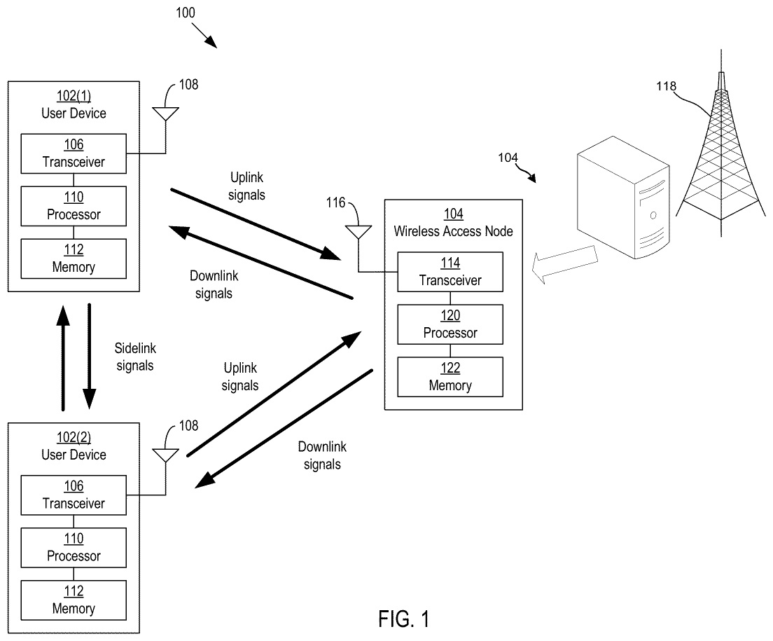

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of user devices 102 and wireless access nodes 104, including two or more user devices 102 without any wireless access nodes 104, only one user device 102 and only one wireless access node 104, only one user device 102 and two or more wireless access nodes 104, two or more user devices 102 and one or more wireless access nodes 104, or two or more wireless access nodes 104 without any user devices 102.

In general, a user device as described herein, such as the user devices 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

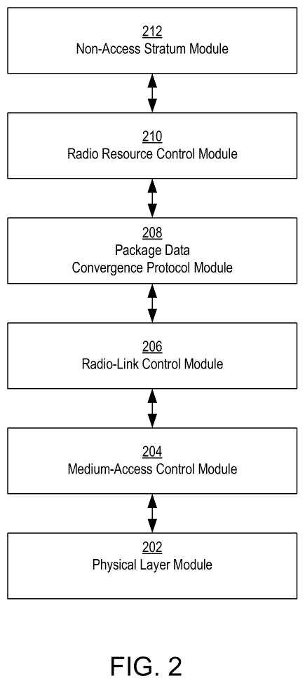

FIG. 2 shows a block diagram of a plurality of modules of a communication node (e.g., a user device 102 or a wireless access node 104), including a physical layer (PHY) entity or module (also called herein as just PHY layer, PHY module, or PHY entity) 202, a medium-access control (MAC) layer entity or module (also called herein as just MAC layer, MAC module, or MAC entity) 204, a radio-link control (RLC) layer entity or module (also called herein as just RLC layer, RLC entity, or RLC module) 206, a package data convergence protocol (PDCP) layer entity or module (also called herein as just PDCP layer, PDCP entity, or PDCP module) 208, a radio resource control (RRC) layer entity or module (also called herein as just RRC layer, RRC entity, or RRC module) 210, and a Non-Access Stratum (NAS) layer entity or module (also called herein as just NAS layer, NAS entity, or NAS module) 212.

In general, as used herein unless expressed otherwise, the terms “layer”, “entity”, and “module”, used alone or in combination with each other, and as used for one or more components of a communication node, is an electronic device, such as electronic circuit, that includes hardware or a combination of hardware and software. In various embodiments, a module or an entity may be considered part of, or a component of, or implemented using one or more of the components of a communication node of FIG. 1, including a processor 110/120, a memory 112/122, a transceiver circuit 106/114, or the antenna 108/116. For example, the processor 110/120, such as when executing computer code stored in the memory 112/116, may perform the functions of a module or entity. Additionally, in various embodiments, the functions that a module or entity performs may be defined by one or more standards or protocols, such as 5G NR for example.

Additionally, the layer entities 202-212 in FIG. 2 may be higher and lower layers relative to each other, with the PHY layer entity 202 being the lowest layer among the layer entities 202-212; the MAC layer entity 204 being a higher layer than the PHY layer entity 202 and lower than the other layer entities 206-212; the RLC layer entity 206 being higher than the PHY and MAC layer entities 202, 204 and lower than the PDCP, RRC, and NAS layer entities 208-212; the PDCP layer entity 208 being higher than the PHY, MAC, and RRC layer entities 202-206 and lower than the RRC and NAS layer entities 210, 212; the RRC layer entity 210 being higher than the PHY, MAC, RRC, and PDCP layer entities 202-208 and lower than the NAS layer entity 212; and the NAS layer entity 212 being the highest layer entity among the layer entities 202-220 shown in FIG. 2. In various embodiments, a communication node of the system 100 may include modules and/or layer entities other than those shown in FIG. 2.

Additionally, in various embodiments, two or more of the communication nodes in the wireless system 100, may be configured to communicate according to vehicle networking standards and/or specifications. As used herein, vehicle networking refers to a large scale system for wireless communication and information exchange involving a vehicle, pedestrians, roadside equipment and the Internet in accordance with any of various communication protocols and data exchange standards. Vehicle networking communications may enhance vehicle performance with respect to driving safety, traffic efficiency, usability or user convenience features, or entertainment. Additionally, in any of various embodiments, vehicle networking communication may be categorized into three types: communication between vehicles (also called vehicle-to-vehicle (V2V)); communication between a vehicle and roadside equipment/network infrastructure (called vehicle-to-infrastructure/vehicle-to-network (V2I/V2N)); and communication between vehicles and pedestrians (called vehicle-to-pedestrian (V2P)). These types of communications are collectively referred to as vehicle-to-everything (V2X) communication. Communication nodes participating in V2X communicates may communicate with each other according to any of various V2X standards or specifications.

In the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a sending node and a receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

For at least some embodiments involving V2X communication, user devices 102 may perform sidelink transmissions. Such sidelink communications in V2X may be referred to as a PC5-based V2X communication or V2X communication. Additionally, for sidelink communications in V2X, user device 102 may communicate sidelink signals to each other using a PC5 interface, where PC5 refers to a reference point where a user device 102 communicates with another user device 102 over a direct channel.

As V2X technology advances, including in the automation industry, scenarios for V2X communications are being increasingly diversified and require higher performance. Examples of advanced V2X services include vehicle platooning, extended sensors, advanced driving (semi-automated driving and full-automated driving), and remote driving. Example performance requirements for these advanced V2X services may include: supporting data packets with a size of 50 to 12,000 bytes, a transmission rate of 2 to 50 messages per second, a maximum end-to-end delay of 3 to 500 milliseconds, a reliability of 90% to 99.999%, a date rate of 0.5 to 1,000 Megabytes per second (Mbps), or a transmission range of 50 to 1,000 meters, as non-limiting examples.

In addition, communication nodes using NR radio access operating with shared spectrum channel access may be configured to operate in different modes, where primary cells (PCells), primary secondary cells (PSCells) or secondary cells (SCells) can be in the shared spectrum, and an SCell may or may not be configured with uplink transmissions. Further, in both channel access modes, the wireless access node 104 and the user device 102 may be configured to apply or perform listen-before-talk (LBT) procedures before performing a transmission on a cell configured with shared spectrum channel access.

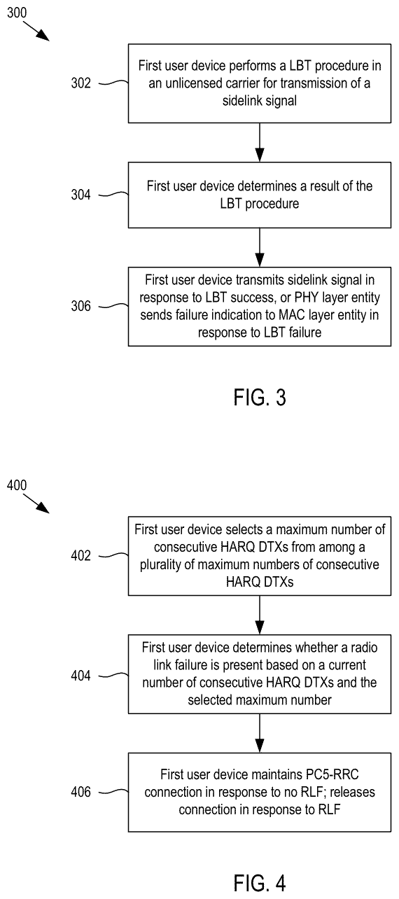

FIG. 3 shows an example method 300 for wireless communication that includes sidelink communication between the first user device 102(1) and the second user device 102(2) on an unlicensed carrier. The embodiments of the method 300 have the first user device 102(1) functioning as a source or transmitting user device that transmits a sidelink signal to the second user device 102(2), and the second user device 102(2) functioning as a destination or receiving user device that receives the sidelink signal from the first user device 102(1).

Also, in general, a licensed carrier is a carrier, frequency band or spectrum that is licensed by a government or other authoritative entity (e.g., the Federal Communications Commission (FCC) in the United States or the European Telecommunications Standards Institute (ETSI) in Europe) to a service provider for exclusive use. An unlicensed carrier, also called a shared spectrum, is a carrier, frequency band or spectrum that is not licensed by a government or other authoritative entity.

At block 302, the first user device 102(1) may perform a listen-before-talk (LBT) procedure in an unlicensed carrier for transmission of a sidelink signal. In general, when a user device 102 wants to transmit a signal (e.g., an uplink signal or a sidelink signal) on a channel in a particular carrier (unlicensed), the user device may perform an LBT procedure in the carrier before transmitting the signal. During an LBT procedure, the user device 102 may listen to or sense the channel to determine whether the channel is available (free) or busy. In response to, or as a result of, performing the LBT procedure, the user device 102 may determine whether the LBT procedure is a success or a failure. A success indicates that the channel is available, and in turn, the user device 102 can proceed to transmit the signal. A failure indicates that the channel is busy, and in turn, the user device 102 determines not to transmit the signal.

In various embodiments, at block 302, the first user device 102(1) may perform the LBT procedure according to a sidelink channel access priority. In particular, during the LBT procedure, an amount of time that the first device 102 has to monitor the channel may depend on a value of the sidelink channel access priority. Also, in the event that the LBT procedure is a success, an amount of time resources the channel occupies may depend on the value of the sidelink channel access priority.

In some of these embodiments, the sidelink channel access priority is a sidelink channel access priority of a sidelink logical. For example, the first user device 102(1) may be configured with a plurality of logical channels, and each logical channel may have or be mapped to an associated priority value for a sidelink channel access priority. The priority values may be the same as or different from each other for the different logical channels. Correspondingly, when the first user device 102(1) determines to transmit data (e.g., data of a MAC protocol data unit (PDU)) as part of the sidelink signal, the first user device 102(1) may determine a logical channel that corresponds to the data, and in turn, determine a priority value corresponding to the logical channel. The first user device 102(1) may then perform the LBT procedure according to the determined priority value.

Additionally, for at least some embodiments, the data (e.g., of the MAC PDU) may correspond to multiple logical channels. Correspondingly, the first user device 102(1) may determine a plurality of priority values for the multiple logical channels, and then select a value corresponding to a highest priority from among the plurality of priority values.

In other embodiments, the sidelink channel access priority is a sidelink channel access priority of a quality of service (QOS) profile. A QoS profile may identify a set of QoS parameters corresponding to data to be transmitted, such as a sidelink PC5 QoS Identifier (PQI), a sidelink guaranteed flow bit rate (GFBR), a sidelink maximum flow bit rate (MFBR), and/or a sidelink range. For such embodiments, the first user device 102(1) may identify a QoS profile corresponding to data to be transmitted in the sidelink transmission. In turn, the first user device 102(1) may identify a priority value corresponding to the QoS profile. The first user device 102(1) may then perform the LBT procedure according to the determined priority value.

In addition or alternatively, the first user device 102(1) may receive the sidelink channel access priority via a RRC message in response to the first user device 102(1) being in a RRC connected state; may receive the sidelink channel access priority via system information in response to the first user device 102(1) being in RRC idle; and/or may be preconfigured with the sidelink channel access priority in response to the UE being out of coverage.

In addition or alternatively, in various embodiments, the first user device 102(1) may use channel access priority classes (CAPCs) of radio bearers (RBs) and MAC control elements (CEs) for priority values for LBT procedures. In some embodiments, the CAPCs of RBs and MAC CEs are either fixed or configurable. For example, the CAPCs may be fixed to the highest priority for sidelink signaling radio bearers (SRBs) and one or more sidelink MAC CEs; configured by the network (wireless access node 104) for sidelink data radio bearers (DRB); or fixed to a lowest priority for other sidelink MAC CEs. When choosing a CAPC of a given DRB, the wireless access node 104 may take into account PQIs of all of the QoS flows multiplexed in the given DRB while considering fairness between different traffic types and transmissions. The communication nodes in the system 100 may use the CAPC of a standardized PQI that best matches QoS characteristics of a non-standardized PQI for a QoS flow corresponding to the non-standardized PQI.

In addition or alternatively, in various embodiments, the first user device 102(1) may select a CAPC as the priority for the LBT procedure by selecting: the highest priority CAPC of a sidelink DRB in response to a transport block (TB) of the sidelink signal to be transmitted including multiple sidelink DRBs; selecting a highest priority CAPC in response to the transport block including at least one sidelink SRB, a sidelink broadcast control channel (SBCCH), or a sidelink MAC CE having the highest priority CAPC; or selecting a lowest priority CAPC in response to the transport block only including one or more sidelink MAC CEs having the lowest priority CAPC.

At block 304, the first user device 102(1) may determine an LBT success or an LBT failure based on the LBT procedure performed at block 302—i.e., whether the LBT procedure results in an LBT success or an LBT failure. At block 306, the first user device 102(1) may transmit the sidelink signal to a second user device 102(2) in response to determining a LBT success; and may not transmit the sidelink signal in response to determining a LBT failure.

Additionally, for at least some embodiments, at block 306, the first user device 102(1) may determine whether a sidelink consistent LBT failure is present according to the LBT procedure performed at block 302 and/or the result of the LBT procedure determined at block 304. In various embodiments, the first user device 102(1) may determine a sidelink consistent LBT failure by counting LBT failures over several LBT procedures or iterations of an LBT procedure. For example, the user device 102 may be configured with a sidelink maximum LBT failure count (SL-Ibt-FailureMaxCount) for sidelink consistent LBT failure detection, a sidelink failure detection timer (SL-Ibt-FailureDetectionTimer) for sidelink consistent LBT failure detection, and a sidelink LBT counter (SL-LBT_COUNTER) for LBT failures, which may initially be set to zero. In event that the first user device 102(1) detects a LBT failure for an LBT procedure, the first user device 102(1) may start or restart the sidelink failure detection timer. In addition, the first user device 102(1) may increment the sidelink LBT counter by one. Subsequently, the first user device 102(1) may compare a current value of the sidelink LBT counter with the sidelink maximum LBT failure count. If the current value is greater than or equal to sidelink maximum LBT failure count, then the first user device 102(1) may detect a sidelink consistent LBT failure. For at least some embodiments, the first user device 102(1) may use the sidelink failure detection timer with the counting. For example, the first user device 102(1) may count during a time duration as measured by the sidelink failure detection timer. That is, the first user device 102(1) may determine whether a sidelink consistent LBT failure has occurred based on the sidelink LBT counter counting during a time duration when the sidelink LBT failure detection timer is running (not expired). In response to the sidelink LBT failure detection timer expiring, or in the event that the sidelink LBT failure detection timer or the sidelink maximum LBT failure count is reconfigured by the MAC layer 204 (or another upper layer), the user device 102 may reset the sidelink LBT counter to zero or another initial value.

Also, for at least some embodiments, the PHY layer 202 of the first user device 102(1) may perform the LBT procedure at block 302, and/or determine whether the LBT procedure is a success or failure at block 304. If the PHY layer 202 determines a LBT failure at block 304, then at block 306, the PHY layer 202 may send a sidelink failure indication to the MAC layer 204 that indicates the LBT failure detected by the PHY layer 202. Also, the MAC layer 204 may be configured with the sidelink maximum LBT failure count, the sidelink failure detection timer, and the sidelink LBT counter, and determine or detect sidelink consistent LBT failures in response to receipt of sidelink failure indications, as previously described.

Additionally, for at least some embodiments, in response to determining a sidelink consistent LBT failure, the first user device 102(1) may switch an active bandwidth part from one bandwidth part to another bandwidth part. In addition or alternatively, in response to determining a sidelink consistent LBT failure, the first user device 102(1) may generate a sidelink LBT failure MAC CE that includes, or is otherwise identified by a MAC subheader that includes a logical channel identification (LCID). In addition or alternatively, the sidelink LBT failure MAC CE may include N octets, where N is an integer of one or more.

Additionally, the N octets includes 8*N X-fields. In some embodiments, for a given carrier i, a corresponding i-th X-field of the N octets is set to a value of one (“1”) in response to a consistent LBT failure being triggered and not cancelled, and may be otherwise set to a value of zero (“0”), such as in response to a consistent LBT failure not being triggered or being cancelled. In other embodiments, for a given destination index i, a corresponding i-th X-field is set to a value of one (“1”) in response to a consistent LBT failure being triggered and not cancelled, and may be otherwise set to a value of zero (“0”), such as in response to a consistent LBT failure not being triggered or being cancelled. In addition or alternatively, the sidelink LBT failure MAC CE may include a list of destination indices for which sidelink consistent LBT failures have been triggered. Each destination index in the list identifies a corresponding destination identification (ID). In addition or alternatively, the sidelink LBT failure MAC CE includes a list of carrier indices for which sidelink consistent LBT failures have been triggered.

Additionally, for at least some embodiments, the first user device 102(1) cancel a triggered or detected sidelink consistent LBT failure. For some of these embodiments, the first user device 102(1) may cancel a triggered or detected sidelink consistent LBT failure in response to the first user device 102(1) transmitting a MAC PDU including a LBT failure MAC CE, and the MAC layer 204 does not receive a LBT failure indication from the PHY layer 202.

For at least some embodiments, in response to a sidelink consistent LBT failure being triggered and not cancelled, and further in response to uplink shared channel (UL-SCH) resources being available for a new uplink transmission and these UL-SCH resources can accommodate a LBT failure MAC CE plus its subheader as a result of logical channel prioritization, the first user device 102(1) may perform a multiplexing and assembly procedure (e.g., one defined by a wireless communication standard or protocol (e.g., TS 38.321) that configures a user device 102 to decide which MAC CEs and/or MAC service data units (SDUs) to include in a MAC PDU for a granted resource) to generate a sidelink LBT failure MAC CE.

In addition or alternatively, the first user device 102(1) may trigger a scheduling request for a sidelink LBT failure MAC CE in response to determining a sidelink consistent LBT failure according to the LBT procedure performed at block 302 and/or the result of the LBT procedure determined at block 304. For at least some of these embodiments, the first user device 102(1) may trigger the scheduling request instead of performing the muliplexing and assembly procedure. In addition or alternatively, for at least some of these embodiments, the first user device 102(1) may receive a scheduling resource configuration for the sidelink LBT failure MAC CE from the wireless access node 104 (the network) before triggering the scheduling request for the sidelink LBT failure MAC CE. In addition or alternatively, for at least some of these embodiments, the first user device 102(1) may transmit the scheduling request to the wireless access node 104 in response to determining the sidelink consistent LBT failure, and further in response to uplink-shared channel (UL-SCH) resources not being available.

In addition or alternatively, in response to detecting a sidelink consistent LBT failure, the first user device 102(1) may transmit sidelink consistent LBT failure indication information that indicates the sidelink consistent LBT failure to the second user device 102(2). For at least some of these embodiments, in event that the first user device 102(1) is configured with multiple carriers, if the sidelink consistent LBT failure is triggered for a first sidelink carrier, the first user device 102(1) may transmit the sidelink consistent LBT failure indication information via another carrier. Additionally, the sidelink consistent LBT failure indication information may include at least one of: an indication of the first sidelink carrier for which the sidelink consistent LBT failure was triggered or an indication that a sidelink consistent LBT failure was triggered or detected.

Also, in event that the first user device 102(1) is configured with only one carrier, and a sidelink consistent LBT failure is triggered for that only one carrier, then the first user device 102(1) may not transmit the sidelink consistent LBT failure indication information until the first user device 102(1) determines it has an available resources. To illustrate, suppose the first user device 102(1) determines to use a time resource t1. Correspondingly, the first user device 102(1) may perform LBT at least from t1-x, where x depends on a CAPC value. If the first user device 102(1) detects at LBT failure at time resource t1, it does not use the time resource t1. The first user device 102(1) then performs another LBT procedure for a next time resource, for example t10. Suppose, for example that the first user device 102(1) determines a LBT success for the LBT procedure at t10. In response, the first user device 102(1) determines it has available resource at t10, and in turn, transmits the sidelink consistent LBT failure information at time resource t10.

In addition or alternatively, in response to detecting a sidelink consistent LBT failure, the first user device 102(1) may transmit sidelink consistent LBT failure indication information that indicates the sidelink consistent LBT failure to the wireless access node 104. The sidelink consistent LBT failure indication information may include at least one of: an indication of the first sidelink carrier for which the sidelink consistent LBT failure was triggered, an identification of the destination (e.g., the second user device 102(1) or a connection between the first and second user devices) and a failure type indication that indicates that the failure being indicated is a sidelink consistent LBT failure.

Additionally, in various embodiments, when the first user device 102(1) wants to communicate with the second user device 102(2) via unicast mode, the first and second user devices 102 may first establish a PC5-RRC connection (also called a PC5 link) with each other. Since a user device may communicate with multiple user devices, such as for different types of services, then a user device may establish multiple PC5-RRC connections with the multiple user devices. The user device may use a destination ID to uniquely identify a PC5-RRC connection it establishes with another user device. Upon the first and second user devices 102 establishing a PC5-RRC connection, they can exchange various information, including UE capability information, RRC configuration messages including measuring configuration information, or bearer configuration information, as non-limiting examples.

Additionally, the first user device 102(1) may detect a radio link failure (RLF) for a PC5-RRC connection it established with the second user device 102(2). Upon detection of a RLF, the first user device 102(1) may release the PC5-RRC connection or destination, which may include releasing DRBs for the PC5-RRC connection and/or discarding NR sidelink communication configuration information for the PC5-RRC connection.

In various embodiments, the first user device 102(1) may determine a RLF for a PC5-RRC connection in response to detecting that a maximum number of consecutive hybrid automatic repeat request (HARQ) discontinuous transmissions (DTXs) has reached a maximum number of consecutive HARQ DTXs (sl-maxNumConsecutiveDTX). In general, a user device may detect a number a HARQ DTXs as being a number of consecutive time slots configured with a physical sidelink feedback channel (PSFCH) that does not receive a HARQ feedback message. The first user device 102(1) may keep track of a current number of consecutive DTXs (numConsecutiveDTX). If the current number reaches or exceeds the maximum number, then the first user device 102(1) may detect a RLF. Accordingly, in various embodiments, the first user device 102(1) may determine if a PSFCH reception is absent on a PSFCH reception occasion. If so, then the first user device 102(1) may increment the current count by one. The first user device 102(1) may then compare whether the current count as reached the maximum number. If so, then the first user device 102(1) may detect a RLF (also called a HARQ-based sidelink RLF). Additionally, for at least some embodiments, the MAC layer 204 keeps track of the current count, and determines whether a RLF has occurred by comparing the current count with the maximum number. If the MAC layer 204 detects a RLF, the MAC layer 204 may notify the RRC layer 210.

In some situations where the first and second user devices 102 communicate on an unlicensed carrier or shared spectrum, if the second user device 102(2) performs an LBT procedure and the result is a LBT failure, then the second user device 102(2) may be unable to send HARQ feedback to the first user device 102(1). For situations where the first and second user devices 102 communicate on a licensed carrier, consecutive HARQ DTXs most often occur due to the first and second user devices 102 moving away from each other. For situations where the first and second user devices 102 communicate on an unlicensed carrier, consecutive HARQ DTXs occur due to the first and second user devices 102 moving away from each other, and also because it is easier to reach the maximum number of consecutive HARQ DTXs for a specific destination. However, if the maximum number of consecutive HARQ DTXs is due to consistent LBT failure, the user device may not want to release the PC5-RRC connection for the destination.

FIG. 4 shows a flow chart of another example method 400 for wireless communication. The method 400 relates to determining a maximum number of consecutive HARQ DTXs that a user device 102 may use to detect a RLF. Accordingly, in various embodiments, the first user device 102(1) may be configured with a plurality of maximum numbers of consecutive HARQ DTXs from which the first user device 102(1) selects in order to detect RLFs. In some embodiments, the first user device 102(1) may receive the plurality of maximum numbers of consecutive HARQ DTXs from the wireless access node 104. In other embodiments, the first user device 102(1) may be preconfigured with the plurality of maximum numbers of consecutive HARQ DTXs. In general, by being preconfigured with certain information, such as a plurality of maximum numbers of consecutive HARQ DTXs, a user device has internal access to the information, and correspondingly does not have to receive that information from another communication node, such as the wireless access node 104, in order to determine or identify the information.

At block 402, the first user device 102(1) may select a maximum number of consecutive HARQ DTXs from among the plurality of maximum numbers of consecutive HARQ DTXs. In some embodiments, the maximum number of consecutive HARQ DTXs that the first user device 102(1) selects is a first maximum number of consecutive HARQ DTXs that is used for one or more unlicensed carriers. Additionally, for at least some embodiments, the plurality of maximum numbers of consecutive HARQ DTXs includes a second maximum number of consecutive HARQ DTXs used for one or more licensed carriers. Accordingly, the first user device 102(1) may select the first maximum number or the second maximum number based on whether the first user device 102(1) is transmitting or wants to transmit in an unlicensed carrier or in a licensed carrier. That is, if the first user device 102(1) is transmitting or wants to transmit in an unlicensed carrier, the first user device 102(1) may select the first maximum number of consecutive HARQ DTXs, and if the first user device 102(1) is transmitting or wants to transmit in a licensed carrier, the first user device 102(1) may select the second maximum number of consecutive HARQ DTXs. Additionally, for at least some embodiments, the first maximum number of consecutive HARQ DTXs for unlicensed carriers is larger than the second maximum number of consecutive HARQ DTXs for licensed carriers.

In addition, for at least some embodiments, the first maximum number of consecutive HARQ DTXs for unlicensed carriers includes multiple values. In some of these embodiments, each maximum number value of the multiple values corresponds to a respective one of one or more ranges of channel occupancy values. For example, a first value may correspond to a first range of channel occupancy values, a second value may correspond to a second range of channel occupancy values, and so on. Also, a channel occupancy is a percentage of samples of received signal strength indicator (RSSI) that are above a predetermined threshold (channelOccupanyThreshold). Also, RSSI is or indicates a linear average of total received power observed in configured orthogonal frequency-divisional multiplexing (OFDM) symbols. In addition or alternatively, RSSI may include a linear average of total received power in configured measurement bandwidth over an N number of resource blocks corresponding to LBT bandwidth with a center frequency of configured absolute radio-frequency channel numbers (ARFCN) by the user device from all sources, including co-channel serving and non-serving cells, adjacent channel interference, and thermal noise. For these embodiments, the first user device 102(1) may determine a first channel occupancy value. Then, the first user device 102(1) may determine a range of channel occupancy values, from among the one or more ranges of channel occupancy values, in which the first channel occupancy value falls. In turn, the first user device 102(1) may determine a maximum number value that corresponds to the determined range of channel occupancy, and select that maximum number value for the first maximum number of consecutive HARQ DTXs.

In embodiments, each maximum number values of the multiple values corresponds to a respective one of one or more ranges of channel busy ratios (CBR). In general, CBR may be or indicate a percentage of sub-channel proportions of sidelink RSSI (s-RSSI) that exceeds a predetermined threshold within a predetermined time period (e.g., 100 milliseconds). For these embodiments, the first user device 102(1) may determine a first CBR value. Then, the first user device 102(1) may determine a range of CBR values, from among the one or more ranges of CBR values, in which the first CBR value falls. In turn, the first user device 102(1) may determine a first maximum number value that corresponds to the determined range of CBR values, and select that first maximum number value for the first maximum number of consecutive HARQ DTXs.

In other embodiments, each maximum number value of the multiple values corresponds to a respective one of one or more ranges of RSSI values. For these embodiments, the first user device 102(1) may determine a first RSSI value. Then, the first user device 102(1) may determine a range of RSSI values, from among the one or more ranges of RSSI values, in which the first RSSI value falls. In turn, the first user device 102(1) may determine a first maximum number value that corresponds to the determined range of CBR values, and select that value for the first maximum number of consecutive HARQ DTXs.

In still other embodiments, each maximum number value of the multiple values corresponds to a respective one of one or more priority values. For these embodiments, the first user device 102(1) may determine a first priority value. Then, the first user device 102(1) may determine a priority value from among the one or more priority values that matches the first priority value, determine a first maximum number value that corresponds to the determined priority value, and select that value for the first maximum number of consecutive HARQ DTXs.

At block 404, after selecting a maximum number of consecutive HARQ DTXs, the first user device 102(1) may determine whether a RLF is present for a PC5-RRC connection it established with the second user device 102(2) based on a current number of consecutive HARQ DTXs and the selected maximum number of consecutive HARQ DTXs. For example, as previously described, the first user device 102(1) may keep track of a current count of consecutive HARQ DTXs, such as by determining if a PSFCH reception is absent on a PSFCH reception occasion, and determining if a current count has reached the selected maximum number from block 402. If the current count has reached the selected maximum number, then the first user device 102(1) may determine that a RLF is present. In addition, if the current count has not reached the selected maximum number, then the first user device 102(2) may determine that a RLF is not present. At block 406, if the first user device 102(1) detected a RLF at block 404, then the first user device 102(1) may release the PC5-RRC connection, which may include releasing DRBs for the PC5-RRC connection and/or discarding NR sidelink communication configuration information for the PC5-RRC connection, as previously described. Additionally, if the first user device 102(1) did not detect a RLF at block 404, then the first user device 102(2) may maintain or keep the PC5-RRC connection it established. If the first user device 102(1) decides to maintain the PC5-RRC connection, it may continue to exchange (transit and/or receive) information with the second user device 102(2) using the PC5-RRC connection.

Additionally, in various embodiments, a user device may perform a sidelink RRC reconfiguration procedure if the user device determines to modify a PC5-RRC connection it has with another user device. The user device may determine to modify a PC5-RRC connection for any of various reasons, such as if it determines to establish, modify, and/or release sidelink DRBs, to configure NR sidelink measurement and reporting, or to configure sidelink channel state information (CSI) reference signal resources and CSI reporting latency bound, as non-limiting examples. If the user device determines to perform a sidelink RRC reconfiguration procedure for a PC5-RRC connection, the user device initiate the reconfiguration procedure with the other user device by transmitting a sidelink RRC reconfiguration (RRCReconfigurationSidelink) message to the other user device with which it established the PC5-RRC connection. If the other user device successfully performs or completes the sidelink RRC reconfiguration procedure according to the RRC reconfiguration sidelink message, the other user device may respond to the sidelink RRC reconfiguration message by transmitting a sidelink RRC reconfiguration completed (RRCReconfigurationCompleteSidelink) message to the initiating user device. Additionally, if the other user device does not successfully perform or complete the sidelink RRC reconfiguration procedure according to the RRC reconfiguration sidelink message, the other user device may respond to the RRC reconfiguration sidelink message by transmitting a sidelink RRC reconfiguration failure (RRCReconfigurationFailureSidelink) message to the initiating user device.

Also, in various embodiments, the first user device 102(1) may determine an LBT failure recovery. In general, congestion in an unlicensed carrier caused by too many user devices wanting to occupy the unlicensed carrier may increase the likelihood of the first user device 102(1) detecting a LBT failure for a LBT procedure. Accordingly, it may be preferable for the first user device 102(1) to stop using the unlicensed carrier. However, after a certain amount of time has elapsed, the number of user devices wanting to occupy the unlicensed carrier may become less, at which time it may be desirable or at least feasible for the first user device 102(1) to communicate on the unlicensed carrier again. Also, if the first user device 102(1) detects a sidelink consistent LBT failure, the first user device 102(1) may report a LBT failure indication for the sidelink consistent LBT failure to the wireless access node 104. In response, the wireless access node 104 may stop allocating sidelink resources in the unlicensed carrier for the reporting first user device 102(1). However, the wireless access node 104 may not know when the number of user devices occupying the unlicensed carrier reduces (congestion in the unlicensed carrier decreases) such that it is desirable for the first user device 102(1) to again communicate on the unlicensed carrier. Accordingly, the first user device 102(1) may continue to perform LBT procedures in the unlicensed carrier after it detects a LBT failure. If, during a subsequent LBT procedure in the unlicensed carrier, it detects a LBT success, it may report the LBT success information to the wireless access node 104. LBT success information may include at least one of: an indication of the first sidelink carrier for which the sidelink consistent LBT failure was recovered, an identification of the destination (e.g., the second user device 102(1) or a connection between the first and second user devices) and a recovery type indication that indicates that the recovery being indicated is a sidelink consistent LBT failure recovery. In response, the wireless access node 104 may allocate sidelink resources for the unlicensed carrier to the first user device 102(1). As used herein, the term LBT failure recovery for a carrier refers to a determination that that a user device can communicate in a carrier following a previous determination that the user device should not communicate in the carrier, such as due to detection of a LBT failure.

In various embodiments, the first user device 102(1) may determine a LBT failure recovery for a sidelink carrier (unlicensed) in response to at least one of: expiration of a timer that the first user device 102(1) started in response to detection of a LBT failure for a LBT procedure and/or an LBT failure indication generated for the detected LBT failure, expiration of a timer that the first user device 102(1) started in response to a sidelink consistent LBT failure triggered or detected according to one or more LBT procedures, a successful result of a LBT procedure, or a channel occupancy rate being lower than a predetermined threshold. In various of these embodiments, the first user device 102(1) may receive a timer value indicating when the timer expires and the predetermined threshold for the channel occupancy rate from the wireless access node 104. In other embodiments, the first user device 102(1) may be preconfigured with the timer value and the predetermined threshold for the channel occupancy rate.

Also, the first user device 102(1) may determine a LBT failure recovery in various embodiments of the method 300 of FIG. 3. For example, in various embodiments, if the first user device 102(1) determines a LBT success for the LBT procedure at block 304, the first user device 102(1) may determine a LBT failure recovery. As another example, if the first user device 102(1) determines a LBT failure for the LBT procedure at block 304, the first user device 102(1) may start a timer. If the timer expires, then the first user device 102(1) may determine a LBT failure recovery. In addition or alternatively, if the first user device 102(1) determines a sidelink consistent LBT failure at block 306, the first user device 102(1) may start a timer. If the timer expires, then the first user device 102(1) may determine a LBT failure recovery.

Additionally, in various embodiments, the first user device 102(1) may prioritize some transmissions over other transmissions. In some situations, if the first user device 102(1) prioritize a first transmission over a second transmission, the first user device 102(1) may drop the second transmission. In the event that the second transmission is a sidelink transmission in an unlicensed carrier, not performing the sidelink transmission may cause the first user device 102(1) to lose the resources it acquired for the sidelink transmission. Consequently, the first user device 102(1) again acquires additional resources for the sidelink transmission. Correspondingly, a package delay budget (PDB) of data for the sidelink transmission may expire, which may lead to a failure of the sidelink data transmission/reception.

To minimize such failures, in various embodiments, the first user device 102(1) may determine whether to prioritize transmissions on unlicensed carriers over transmissions on licensed carriers and/or whether to prioritize sidelink transmissions over uplink transmissions.

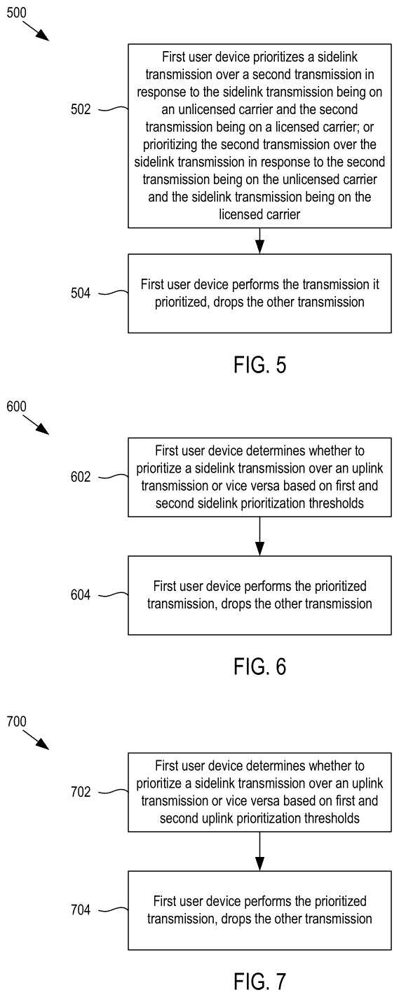

FIG. 5 shows an example method 500 for wireless communication that includes prioritizing transmissions. At block 502, the first user device 102(1) may prioritize a sidelink transmission over a second transmission in response to the sidelink transmission being on an unlicensed carrier and the second transmission being on a licensed carrier; or the first user device 102(1) may prioritize the second transmission over the sidelink transmission in response to the second transmission being on the unlicensed carrier and the sidelink transmission being on the licensed carrier.

Additionally, in various embodiments, the first user device 102(1) may determine to prioritize the transmissions if it is unable to simultaneously perform the sidelink transmission and second transmissions. The first user device 102(1) may prioritize the sidelink transmission over the second transmission because the sidelink transmission is the transmission being performed on an unlicensed carrier. In other embodiments, if the second transmission is to be performed on an unlicensed carrier and the sidelink transmission is to be performed on a licensed carrier, the first user device 102 may prioritize the second transmission over the sidelink transmission since the second transmission is the transmission performed on the unlicensed carrier. Additionally, as mentioned, the second transmission may be another sidelink transmission or an uplink transmission. In various embodiments, the first user device 102(1) may prioritize the sidelink transmission on the unlicensed carrier in response to the uplink transmission not being prioritized by the Non-Access-Stratum (NAS) layer entity 212 of the first user device 102(1) or a layer entity higher than the PHY layer entity 202 of the first user device 102(1).

At block 504, the first user device 102(1) may perform the sidelink transmission on the unlicensed carrier it prioritized over the second transmission on the licensed carrier, such as by transmitting a sidelink signal associated with the sidelink transmission to the second user device 102(2). Correspondingly, the first user device 102(1) may drop the second transmission on the licensed carrier.

Additionally, in various embodiments, the first user device 102(1) may determine whether to prioritize a sidelink transmission over an uplink transmission or vice versa. In some of these embodiments, the prioritization may be based on a first sidelink prioritization threshold for sidelink transmissions on licensed carriers and a second sidelink prioritization threshold for sidelink transmissions on unlicensed carriers. In some embodiments, the first user device 102(1) may receive the first and second sidelink prioritization thresholds from the wireless access node 104. In other embodiments, the first user device 102(1) may be preconfigured with the first and second sidelink prioritization thresholds.

FIG. 6 shows an example method 600 for wireless communication that includes prioritization of sidelink and uplink transmissions. At block 602, the first user device 102(1) may determine to whether to prioritize a sidelink transmission over an uplink transmission, or vice versa, based on at least one of the first sidelink prioritization threshold or the second sidelink prioritization threshold. For at least some of these embodiments, if the first user device 102(1) is not able to simultaneously perform a sidelink transmission with an uplink transmission, and if the uplink transmission is not prioritized by the MAC layer 204, and further if the first user device 102(1) is to perform the sidelink transmission in a licensed carrier, and if a value of a highest priority of logical channels or a MAC CE in a MAC PDU for the sidelink transmission is less than a value of the first sidelink prioritization threshold for licensed carriers, then the first user device 102(1) may prioritize the sidelink transmission over the uplink transmission. Also, if the first user device 102(1) is to perform the sidelink transmission in an unlicensed carrier, and if a value of a highest priority of logical channels or a MAC CE in a MAC PDU for the sidelink transmission is less than a value of the second sidelink prioritization threshold for unlicensed carriers, then the first user device 102(1) may prioritize the sidelink transmission over the uplink transmission.

At block 604, the first user device 102(1) may perform the prioritized transmission, such as by transmitting the signal associated with the prioritized transmission. Correspondingly, the first user device 102(1) may drop the other transmission it did not prioritize.

FIG. 7 shows another example method 700 for wireless communication that includes prioritization of sidelink and uplink transmissions. At block 702, the first user device 102(1) may determine to whether to prioritize a sidelink transmission over an uplink transmission, or vice versa, based on at least one of a first uplink prioritization threshold for uplink transmissions on licensed carriers or a second sidelink prioritization threshold for uplink transmissions on unlicensed carriers. In some embodiments, the first user device 102(1) may receive the first and second uplink prioritization thresholds from the wireless access node 104. In other embodiments, the first user device 102(1) may be preconfigured with the first and second uplink prioritization thresholds. Also, for at least some of these embodiments that uses first and second uplink prioritization thresholds, if the first user device 102(1) is to perform the sidelink transmission on a licensed carrier, and if a value of a highest priority of logical channels in a MAC PDU for the uplink transmission is less than a value of the first uplink prioritization threshold for licensed carriers, then the first user device 102(1) may prioritize the uplink transmission over the sidelink transmission. Also, if the first user device 102(1) is to perform the sidelink transmission in an unlicensed carrier, and if a value of a highest priority of logical channels in a MAC PDU for the uplink transmission is less than a value of the second uplink prioritization threshold for unlicensed carriers, then the first user device 102(1) may prioritize the uplink transmission over the sidelink transmission.

At block 704, the first user device 102(1) may perform the prioritized transmission, such as by transmitting the signal associated with the prioritized transmission. Correspondingly, the first user device 102(1) may drop the other transmission it did not prioritize.

Additionally, in various embodiments, some or all of the methods 300, 400, 500, 600, and 700 described with references to FIGS. 3-7 respectively, may be performed independent of each other or in combination with each other. For example, the actions related to the LBT procedures and detection of LBT failures and sidelink consistent LBT failures described with reference to FIG. 3 may be performed in combination with the maximum number of consecutive HARQ DTX selection and/or detection of RLFs described with reference to FIG. 4, and/or in combination with one or more of the prioritization schemes described with reference to FIGS. 5-7, such as by one or more of the actions being performed for the same sidelink transmissions. As another example, the maximum number of consecutive HARQ DTX selection and/or detection of RLFs described with reference to FIG. 4 be performed in combination with one or more of the prioritization schemes described with reference to FIGS. 5-7, such as by one or more of the actions being performed for the same sidelink transmissions. Various combinations may be possible.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication, the method including: performing, with a first user device, a listen-before-talk (LBT) procedure in an unlicensed carrier for a sidelink transmission; determining, with the first user device, a result of the LBT procedure; in response to determining that the result is a LBT success, transmitting, with the first user device, a sidelink signal on a channel in the unlicensed carrier to a second user device; and in response to determining that the result is a LBT failure, sending, with a physical layer entity of the first user device, a LBT failure indication to a medium access control (MAC) layer entity of the first user device.

A second aspect includes the first aspect, and further wherein performing the LBT procedure in the unlicensed carrier comprises: performing, with the first user device, the LBT procedure according to a sidelink channel access priority of a sidelink logical channel or a quality of service (QOS) profile.

A third aspects includes any of the first or second aspects, and further wherein the sidelink signal comprises a sidelink transport block, the method further comprising selecting, with the first user device, a channel access priority class (CAPC) for the LBT procedure, wherein the selecting comprises one of: selecting the highest priority CAPC of a sidelink data radio bearer in response to the transport block including multiple sidelink data radio bearers; selecting a highest priority CAPC in response to the transport block comprising at least one sidelink signaling radio bearer, a sidelink broadcast control channel (SBCCH), or a sidelink medium access control (MAC) control element (CE) having the highest priority CAPC; or selecting a lowest priority CAPC in response to the transport block only including one or more sidelink medium access control (MAC) control elements (CEs) with the lowest priority CAPC.

A fourth aspect includes any of the first through third aspects, and further includes: determining, with the first user device, a sidelink consistent LBT failure according to the LBT procedure.

A fifth aspect includes the fourth aspect, and further includes: in response to determining the sidelink consistent LBT failure, switching an active sidelink bandwidth part from a bandwidth part to another bandwidth part.

A sixth aspect includes any of the fourth or fifth aspects, and further includes: in response to determining the sidelink consistent LBT failure according to the LBT procedure, generating, with the first user device, a sidelink LBT failure MAC control element (CE).

A seventh aspect includes the sixth aspect, and further wherein the sidelink LBT failure MAC CE is identified by a MAC subheader that includes a logical channel identification (LCID).

An eighth aspect includes the sixth aspect, and further wherein the sidelink LBT failure MAC CE comprises: a list of destination indices for which sidelink consistent LBT failures have been triggered, wherein each destination index in the list identifies a destination identification; a list of carrier indices for which sidelink consistent LBT failures have been triggered; or N octets comprising 8*N X-fields, wherein N is an integer of one or more, and wherein: an i-th X-field is set to a value of 1 in response to a consistent LBT failure being triggered and not cancelled for a carrier index i, and the i-th X-field is set to a value of 0 in response to the consistent LBT failure not being triggered or being cancelled; or the i-th X-field is set to a value of 1 in response to a consistent LBT failure being triggered and not cancelled for a destination index i, and the i-th X-field is set to a value of 0 in response to the consistent LBT failure not being triggered or being cancelled.

A ninth aspect includes the sixth aspect, and further includes: triggering, with the first user device, a scheduling request for the sidelink LBT failure MAC CE.

A tenth aspect includes the ninth aspect, and further includes: before triggering the scheduling request, receiving, with the first user device, a scheduling request resource configuration for the sidelink LBT failure MAC CE from a wireless access node.

An eleventh aspect includes any of the first through tenth aspects, and further includes: selecting, with the first user device, a first maximum number of consecutive hybrid automatic repeat request (HARQ) discontinuous transmissions (DTXs) from among a plurality of maximum numbers of consecutive HARQ DTXs.

A twelfth aspect includes the eleventh aspect, and further includes: receiving, with the first user device, the plurality of maximum numbers of consecutive HARQ DTXs from a wireless access node.

A thirteenth aspect includes the eleventh aspect, further wherein the first user device is preconfigured with the plurality of maximum numbers of consecutive HARQ DTXs.

A fourteenth aspect includes any of the eleventh through thirteenth aspects, and further wherein the first maximum number of consecutive HARQ DTXs is used for one or more unlicensed carriers, and wherein a second maximum number of consecutive HARQ DTXs of the plurality of maximum numbers of consecutive HARQ DTXs is used for one or more licensed carriers, wherein selecting the first maximum number comprises selecting the first maximum number in response to the sidelink transmission being on the unlicensed carrier.

A fifteenth aspect includes the fourteenth aspect, and further wherein the first maximum number of consecutive HARQ DTXs comprises multiple maximum number values, wherein each maximum number value in the set is: associated with a respective one of one or more ranges of channel occupancy values; associated with a respective one of one or more ranges of received signal strength indicator (RSSI) values; or associated with a respective one of one or more priority values.

A sixteenth aspect includes the fifteenth aspect, and further wherein each of the multiple maximum number values in the set corresponds to the respective one of the one or more ranges of channel occupancy values, the method further comprising: determining a first channel occupancy value, wherein selecting the first maximum number of consecutive HARQ DTXs comprises selecting the first maximum number in response to the first maximum number corresponding to a range of channel occupancy values in which the first channel occupancy value falls.

A seventeenth aspect includes the fifteenth aspect, and further wherein each of the multiple maximum number values in the set corresponds to the respective one of the one or more ranges of RSSI values, the method further comprising: determining a first RSSI value, wherein selecting the first maximum number of consecutive HARQ DTXs comprises selecting the first maximum number in response to the first maximum number corresponding to a range of RSSI values in which the first RSSI value falls.

An eighteenth aspect includes the fifteenth aspect, and further wherein each of the multiple maximum number of values in the set corresponds to the respective one of the one or more priority values, the method further comprising: determining a first priority value, wherein selecting the first maximum number of consecutive HARQ DTXs comprises selecting the first maximum number in response to the first maximum number corresponding to a priority value of the one or more priority values that matches the first priority value.

A nineteenth aspect includes any of the first through eighteenth aspects, and further includes: detecting, with the first user device, a sidelink consistent LBT failure in the unlicensed carrier based on the LBT procedure; and transmitting, with the first user device, sidelink consistent LBT failure indication information that indicates the sidelink consistent LBT failure to the second user device.

A twentieth aspect includes any of the first through nineteenth aspects, and further includes: detecting, with the first user device, a sidelink consistent LBT failure in the unlicensed carrier according to the LBT procedure; and transmitting, with the first user device, sidelink consistent LBT failure indication information that indicates the sidelink consistent LBT failure to a wireless access node.

A twenty-first aspect includes the twentieth aspect, and further wherein the sidelink consistent LBT failure indication information comprises at least one of: a carrier indication, a destination identity indication, or a failure type indication.

A twenty-second aspect includes any of the first through twenty-first aspects, and further includes: determining, with the first user device, a LBT failure recovery for the unlicensed carrier for the sidelink transmission in response to at least one of: expiration of a timer started in response to: an LBT failure indication from the LBT procedure or a sidelink consistent LBT failure triggered according to the LBT procedure; a result of the LBT procedure being a success; or a channel occupancy rate being lower than a predetermined threshold.

A twenty-third aspect includes the twenty-second aspect, and further includes: receiving, with the first user device, a timer value indicating when the timer expires and the predetermined threshold from a wireless access node in response to the first user device being in coverage of the wireless access node.

A twenty-fourth aspect includes the twenty-second aspect, and further wherein a timer value indicating when the timer expires and the predetermined threshold are preconfigured with the first user device.

A twenty-fifth aspect includes any of the first through twenty-fourth aspects, and further wherein the LBT success corresponds to a recovery, further in response to determining that the result is the LBT success, transmitting, with the first user device, information indicating the LBT success to a wireless access node, wherein the information indicating the LBT success comprises at least one of: the unlicensed carrier, a destination identification, or a recovery type indication indicating that the recovery is from a sidelink consistent LBT failure.

A twenty-sixth aspect includes any of the first through twenty-fifth aspects, and further includes: prioritizing, with the first user device, the sidelink transmission over a second transmission in response to the sidelink transmission being on the unlicensed carrier and the second transmission being on a licensed carrier; or prioritizing, with the first user device, the second transmission over the sidelink transmission in response to the second transmission being on the unlicensed carrier and the sidelink transmission being on the licensed carrier.

A twenty-seventh aspect includes the twenty-sixth aspect, and further wherein the second transmission comprises an uplink transmission.

A twenty-eighth aspect includes the twenty-seventh aspect, and further wherein prioritizing the sidelink transmission on the unlicensed carrier over the uplink transmission on the licensed carrier is in response to the uplink transmission not being prioritized by a Non-Access-Stratum (NAS) layer entity of the first user device or a layer entity higher than a physical (PHY) layer entity of the first user device.

A twenty-ninth aspect includes any of the twenty-sixth through twenty-eighth aspects, and further includes: determining, with the first user device, a first sidelink prioritization threshold for transmissions on unlicensed carriers and a second sidelink prioritization threshold for transmissions on licensed carriers, wherein prioritizing the sidelink transmission over the second transmission is based on the first sidelink prioritization threshold and the second sidelink prioritization threshold.

A thirtieth aspect includes the twenty-ninth aspect, and further includes: receiving, with the first user device, the first sidelink prioritization threshold and the second sidelink prioritization threshold from a wireless access node.

A thirty-first aspect includes the twenty-ninth aspect, and further wherein the first user device is preconfigured with the first sidelink prioritization threshold and the second sidelink prioritization threshold.

A thirty-second aspect includes any of the twenty-ninth through thirty-first aspects, and further includes: determining, with the first user device, a first uplink prioritization threshold for transmissions on unlicensed carriers and a second uplink prioritization threshold for transmissions on licensed carriers, the method further comprising: prioritizing, with the first user device, an uplink transmission over the sidelink transmission based on the first uplink prioritization threshold and the second uplink prioritization threshold.

A thirty-third aspect includes the thirty-second aspect, and further includes: receiving, with the first user device, the first uplink prioritization threshold and the second uplink prioritization threshold from a wireless access node.

A thirty-fourth aspect includes the thirty-second aspect, and further wherein the first user device is preconfigured with the first uplink prioritization threshold and the second uplink prioritization threshold.

A thirty-fifth aspect includes a wireless communications apparatus comprising a processor and a memory, wherein the processor is configured to read code from the memory to implement any of the first through thirty-fourth aspects.

A thirty-sixth aspect includes a computer program product comprising a computer-readable program medium comprising code stored thereupon, the code, when executed by a processor, causing the processor to implement any of the first through thirty-fourth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
performing, with a first user device, a listen-before-talk (LBT) procedure in an unlicensed carrier for a sidelink transmission;
determining, with the first user device, a result of the LBT procedure;
in response to determining that the result is a LBT success, transmitting, with the first user device, a sidelink signal on a channel in the unlicensed carrier to a second user device; and
in response to determining that the result is a LBT failure, sending, with a physical layer entity of the first user device, a LBT failure indication to a medium access control (MAC) layer entity of the first user device.

2. The method of claim 1, wherein performing the LBT procedure in the unlicensed carrier comprises: performing, with the first user device, the LBT procedure according to a sidelink channel access priority of a sidelink logical channel or a quality of service (QOS) profile.

3. The method of claim 1, wherein the sidelink signal comprises a sidelink transport block, the method further comprising selecting, with the first user device, a channel access priority class (CAPC) for the LBT procedure, wherein the selecting comprises one of:
selecting the highest priority CAPC of a sidelink data radio bearer in response to the transport block including multiple sidelink data radio bearers;
selecting a highest priority CAPC in response to the transport block comprising at least one sidelink signaling radio bearer, a sidelink broadcast control channel (SBCCH), or a sidelink medium access control (MAC) control element (CE) having the highest priority CAPC; or
selecting a lowest priority CAPC in response to the transport block only including one or more sidelink medium access control (MAC) control elements (CEs) with the lowest priority CAPC.

4. The method of claim 1, further comprising:
determining, with the first user device, a sidelink consistent LBT failure according to the LBT procedure.

5. The method of claim 4, further comprising:
in response to determining the sidelink consistent LBT failure, switching an active sidelink bandwidth part from a bandwidth part to another bandwidth part.

6. The method of claim 4, further comprising:
in response to determining the sidelink consistent LBT failure according to the LBT procedure, generating, with the first user device, a sidelink LBT failure MAC control element (CE).

7. The method of claim 6, wherein the sidelink LBT failure MAC CE is identified by a MAC subheader that includes a logical channel identification (LCID).

8. The method of claim 6, wherein the sidelink LBT failure MAC CE comprises:
a list of destination indices for which sidelink consistent LBT failures have been triggered, wherein each destination index in the list identifies a destination identification; or
a list of carrier indices for which sidelink consistent LBT failures have been triggered; or
N octets comprising 8*N X-fields, wherein N is an integer of one or more, and wherein:
an i-th X-field is set to a value of 1 in response to a consistent LBT failure being triggered and not cancelled for a carrier index i, and the i-th X-field is set to a value of 0 in response to the consistent LBT failure not being triggered or being cancelled; or
the i-th X-field is set to a value of 1 in response to a consistent LBT failure being triggered and not cancelled for a destination index i, and the i-th X-field is set to a value of 0 in response to the consistent LBT failure not being triggered or being cancelled.

9. The method of claim 6, further comprising:
triggering, with the first user device, a scheduling request for the sidelink LBT failure MAC CE.

10. The method of claim 9, further comprising:
before triggering the scheduling request, receiving, with the first user device, a scheduling request resource configuration for the sidelink LBT failure MAC CE from a wireless access node.

11. The method of claim 1, further comprising:
selecting, with the first user device, a first maximum number of consecutive hybrid automatic repeat request (HARQ) discontinuous transmissions (DTXs) from among a plurality of maximum numbers of consecutive HARQ DTXs.

12. The method of claim 11, further comprising:
receiving, with the first user device, the plurality of maximum numbers of consecutive HARQ DTXs from a wireless access node.

13. The method of claim 11, wherein the first user device is preconfigured with the plurality of maximum numbers of consecutive HARQ DTXs.

14. The method of claim 11, wherein the first maximum number of consecutive HARQ DTXs is used for one or more unlicensed carriers, and wherein a second maximum number of consecutive HARQ DTXs of the plurality of maximum numbers of consecutive HARQ DTXs is used for one or more licensed carriers,
wherein selecting the first maximum number comprises selecting the first maximum number in response to the sidelink transmission being on the unlicensed carrier.

15. The method of claim 14, wherein the first maximum number of consecutive HARQ DTXs comprises multiple maximum number values, wherein each maximum number value in the set is:
associated with a respective one of one or more ranges of channel occupancy values;
associated with a respective one of one or more ranges of received signal strength indicator (RSSI) values; or
associated with a respective one of one or more priority values.

16. The method of claim 15, wherein each of the multiple maximum number values in the set corresponds to the respective one of the one or more ranges of channel occupancy values, the method further comprising: determining a first channel occupancy value,
wherein selecting the first maximum number of consecutive HARQ DTXs comprises selecting the first maximum number in response to the first maximum number corresponding to a range of channel occupancy values in which the first channel occupancy value falls.

17. The method of claim 15, wherein each of the multiple maximum number values in the set corresponds to the respective one of the one or more ranges of RSSI values, the method further comprising: determining a first RSSI value,
wherein selecting the first maximum number of consecutive HARQ DTXs comprises selecting the first maximum number in response to the first maximum number corresponding to a range of RSSI values in which the first RSSI value falls.

18. The method of claim 15, wherein each of the multiple maximum number of values in the set corresponds to the respective one of the one or more priority values, the method further comprising: determining a first priority value,
wherein selecting the first maximum number of consecutive HARQ DTXs comprises selecting the first maximum number in response to the first maximum number corresponding to a priority value of the one or more priority values that matches the first priority value.

19. The method of claim 1, further comprising:
detecting, with the first user device, a sidelink consistent LBT failure in the unlicensed carrier based on the LBT procedure; and
transmitting, with the first user device, sidelink consistent LBT failure indication information that indicates the sidelink consistent LBT failure to the second user device.

20. The method of claim 1, further comprising:
detecting, with the first user device, a sidelink consistent LBT failure in the unlicensed carrier according to the LBT procedure; and
transmitting, with the first user device, sidelink consistent LBT failure indication information that indicates the sidelink consistent LBT failure to a wireless access node.
